(19) United States
(12) Patent Application Publication
(10) Pub. No.: US 2021/0186230 A1
(43) Pub. Date: Jun. 24, 2021

(54) FASTENING DEVICE FOR FASTENING A MATTRESS

(71) Applicant: Hans-Joachim KLEEBERG, Erlangen (DE)

(72) Inventor: Hans-Joachim KLEEBERG, Erlangen (DE)

(21) Appl. No.: 17/048,245

(22) PCT Filed: Jun. 14, 2018
(86) PCT No.: PCT/EP2018/065831

§ 371 Date: Oct. 16, 2020

(30) Foreign Application Priority Data
Apr. 18, 2018 (DE) 10 2018 109 253.9

(51) Int. Cl. A47C 31/02; A47C 20/04; A47C 21/02; A61G 7/05; A61G 7/015; A61G 7/16

(52) U.S. Cl. CPC A47C 31/023; A47C 20/041; A47C 21/026; A61G 7/16; A61G 7/05; A61G 7/015; A47C 31/026

(57) ABSTRACT

A fastening device for fastening a mattress to a mattress support and a bed, in particular a hospital bed, having such a fastening device. The mattress support has multiple support sections which are articulated to one another. In a central section of the mattress support there is a support panel having first holding cut-outs. In a lower leg section of the mattress support there is a support panel having second holding cut-outs. The first holding cut-outs are assigned first fastening elements fastened to the mattress, and the second holding cut-outs are assigned second fastening elements fastened to the mattress. The first fastening elements are fastened to at least two first planar holding parts which are situated on opposite sides of the mattress in a transverse direction of the mattress, forming a transverse distance. The second fastening elements are preferably arranged on a single common second planar holding part which extends over more than half the mattress width in the transverse direction of the mattress, preferably over virtually the whole mattress width.

### CROSS REFERENCE TO RELATED APPLICATIONS

This application is a National Stage of PCT Application No. PCT/EP2018/065831 filed on Jun. 14, 2018, which claims priority to German Patent Application No. DE 10 2018 109 253.9 filed on Apr. 18, 2018, the contents each of which are incorporated herein by reference thereto.

### TECHNICAL FIELD

The invention refers to a fastening device for fastening a mattress on a mattress support, particularly a mattress support of a nursery bed. The invention refers also to a nursery bed having a mattress support as well as a mattress that is attached or can be attached on the mattress support by means of the fastening device.

### BACKGROUND

In some beds and particularly nursery beds in therapy units such as hospitals, care centers or rehabilitation clinics, frequently beds are provided in which the mattress support comprises multiple support sections that can be angled relative to each other. In doing so, the upper body of a patient can be raised for example. Also patients can be brought in a sitting position in order to facilitate standing up. Many patients are unable to raise themselves and to stand up without this support.

If the mattress support is brought into a seat position, the mattress shall not be distanced from the mattress support, but must further on abut on the mattress support and shall abut on the mattress support as tight as possible. If the mattress is released from the mattress support, the mattress tries to assume its non-elastically deformed stretched position. An unintentional release of the fastening device can be dangerous for the patient. The patient and also the support and caring personnel must be able to rely on the mattress remaining rigidly anchored at the mattress support, if individual support sections of the mattress support are angled for raising the patient.

In order to ensure such a rigid connection, mattresses are frequently fastened by means of belts and bands on the mattress support. These belts or bands surround the mattress as well as the mattress support completely. In other known fastening devices toggle locks are used that are connected with the mattress. The toggle locks can extend through the interstices of a slatted frame that serves as mattress support and can be rotated below the slatted frame such that the toggle extends below two adjacent slats of the slatted frame and thereby fastens the mattress on the slatted frame.

In these known fastening devices the fastening and release of the mattress is time consuming. Particularly in nursery and therapy units the mattresses are frequently removed from the mattress support, cleaned and re-attached to the mattress support. This requires a lot of time that is then not available for the personnel for proper care of the patient.

DE 10 2005 118 235 A1 describes a fastening device that considers the drawbacks mentioned above and that provides an improved fastening of the mattress on the mattress support. However, the practical test has shown that also this known fastening device can be further improved.

Therefore it can be considered as an object of the present invention to provide a fastening device that on one hand ensures a simple release and attachment of the mattress to the mattress support and on the other hand reliably holds the mattress in each position on the mattress support and ensures a long lifetime.

### BRIEF DESCRIPTION

Disclosed is a fastening device for attaching a mattress to a mattress support, wherein the mattress comprises a bottom side, a top side opposite the bottom side, two longitudinal sides extending in a longitudinal direction of the mattress and two transverse sides extending in a transverse direction of the mattress, at least two first plate-shaped holding parts that are arranged with a transverse distance to each other in the transverse direction of the mattress and having at least one second plate-shaped holding part that is larger in the transverse direction of the mattress than half a width of the mattress, wherein the plate-shaped holding parts are arranged at the mattress, multiple first fastening elements and multiple second fastening elements that project from the bottom side of the mattress and comprise a fastening head with a distance to the bottom side of the mattress, wherein at least one first fastening element is attached to each of the at least two first plate-shaped holding parts and wherein multiple second fastening elements are attached to the at least one second plate-shaped holding part, and multiple first holding recesses and multiple second holding recesses at the mattress support, each comprising an insertion opening and a holding slot adjoining thereto, wherein an outer dimension of the insertion opening is larger than an outer dimension of the fastening head such that the fastening head can be inserted in the assigned insertion opening and wherein a slot width of the holding slot is smaller than the outer dimension of the fastening head.

The fastening device is configured to attach a mattress to a mattress support. The mattress has a bottom side, a top side opposite the bottom side, two longitudinal sides extending in a mattress longitudinal direction and two transverse sides extending in a mattress transverse direction. The mattress longitudinal direction and the mattress transverse direction are orientated orthogonal to each other. The longitudinal sides and the transverse sides connect the bottom side with the top side of the mattress respectively.

The fastening device comprises at least two first plate-shaped holding parts and at least one second plate-shaped holding part. The two first plate-shaped holding parts are arranged with transverse distance to each other in mattress transverse direction. They are particularly identically configured and can be configured as a square or rectangle for example. The at least one second plate-shaped holding part has a larger width in mattress transverse direction than the first plate-shaped holding part and comprises a width that is larger than the half mattress width in mattress transverse direction. Preferably the width of the at least one second plate-shaped holding part has an amount of 70% to 90% of the mattress width in mattress transverse direction.

All of the plate-shaped holding parts are attached to the mattress and are arranged between two directly adjacent layers of the mattress in a preferred embodiment. The layers of the mattress can be glued to each other such that the plate-shaped holding parts are firmly anchored in the mattress.

Preferably the plate-shaped holding parts consist of plastic and can be manufactured by extrusion. In a preferred embodiment the plate-shaped holding parts consist of polyethylene.

Preferably each plate-shaped holding part is formed by one respective integral holding plate that is configured without seams or joints. The holding plate has preferably a thickness of less than 5 mm and in one embodiment a thickness of 3 mm. The first holding plates have a surface area in their extension plane of at least 100 cm² or at least 200 cm². In an embodiment the first holding plates have a surface area of 225 cm² and are, for example, configured as square-shaped holding plates with an edge length of 15 cm. The at least one second holding plate or the only second holding plate has at least a surface area of 800 cm² or 1000 cm². In one embodiment the second holding plate has a surface area of 1200 cm² and is, for example, configured as a rectangular-shaped holding plate with a width in mattress transverse direction of 80 cm and a length in mattress longitudinal direction of 15 cm.

The fastening device further comprises multiple first fastening elements and multiple second fastening elements. All fastening elements project from the bottom side of the mattress and extend through at least one part or layer of the mattress. They are connected by an inner end with one assigned plate-shaped holding part respectively and have a fastening head at the opposite outer end respectively that is arranged with distance to the bottom side of the mattress. Exactly one first fastening element or at least one first fastening element is attached at each first plate-shaped holding part respectively. Multiple second fastening elements are attached at the at least one second plate-shaped holding part respectively. Preferably one single second plate-shaped holding part is provided on which all of the second fastening elements are attached.

The mattress support is provided with multiple first and multiple second holding recesses. Each holding recess has an insertion opening and a holding slot adjoining the insertion opening. The insertion opening has an outer dimension that is larger than the outer dimension of the assigned fastening head of a respective fastening element. The fastening head can thus be inserted into the insertion opening. A width of the holding slot that is measured transverse to its extension direction is smaller than the outer dimension of the fastening head. After the insertion the fastening head can be moved out of the insertion opening such that the respective fastening element extends below the holding slot of the holding recess by means of the fastening head and thus locks the mattress to the mattress support.

The fastening elements form two groups according to the invention. The first fastening elements are arranged at separate plate-shaped holding parts. In the area in which the first fastening elements or the first plate-shaped holding parts are arranged in the mattress, the mattress can be deformed, particularly in mattress transverse direction. In the area in which the second fastening elements or the at least one second plate-shaped holding part is present, the mattress can be deformed in mattress transverse direction only in a limited manner due to the relatively large surface or width of the at least one second plate-shaped holding part, however, comprises in this area a very stable attachment of the mattress to the mattress support. The mattress is only able to move slightly away from the mattress support in the area of the at least one second plate-shaped holding part, which is particularly advantageous, if the mattress support takes a seat position. Preferably the at least one second plate-shaped holding part is arranged with the second fastening elements in a support section of the mattress support forming a lower leg section. Specifically here it is important to retain the mattress to the mattress support so that the patient can place the feet on the floor for the purpose of standing up without being impeded by the mattress. Thereby the lower leg section of the mattress support shall be particularly inclined relative to the vertical away from the feet below the central section of the mattress support serving to seat and the mattress shall, however, be reliably held thereon. In doing so, it is allowed for the patient to place the feet sufficiently far backward on the floor in order to bring the center of gravity above the feet and to be able to stand up.

It is preferred that the holding slots of the first holding recesses extend in a support transverse direction and/or that the holding slots of the second holding recesses extend in a support longitudinal direction. The support transverse direction and the support longitudinal direction are orientated orthogonal to each other. If the attachment between the mattress and the support is established, the support transverse direction corresponds to the mattress transverse direction and the support longitudinal direction corresponds to the mattress longitudinal direction.

Particularly the first plate-shaped holding parts are arranged with transverse distance to each other in mattress transverse direction, wherein this transverse distance is preferably as large as the slot length of a holding slot of one of the first holding recesses and is in one embodiment larger than the half mattress width in mattress transverse direction. Due to this sufficiently large transverse distance, an elastic deformability of the mattress in mattress transverse direction is ensured in the area of the at least two first plate-shaped holding parts.

In a preferred embodiment exactly one first fastening element is attached on each first plate-shaped holding part and further preferably exactly one second plate-shaped holding part is present to which all of the second fastening elements are attached.

The width of the at least one second plate-shaped holding part can be at least 70% or at least 80% or at least 90% of the mattress width. The wider the at least one second plate-shaped holding part is, the better the mattress is fixed in this area. The at least one second plate-shaped holding part has particularly a width that is smaller than the mattress width.

It is preferred that two of the fastening elements have an element distance in the non-deformed initial position of the mattress in mattress longitudinal direction and/or mattress transverse direction that is different from an opening distance that the insertion openings of the assigned holding recesses comprise. Due to this configuration, the fastening elements extend below the holding recesses in the area of the respective holding slots, because the mattress tries to takes its non-deformed initial position. By elastically deforming of the mattress, the fastening heads can be arranged in the area of the insertion openings and the mattress can be attached to the mattress support or can be released from the mattress support.

It is also advantageous that two first fastening elements comprise a first element distance in mattress transverse direction. Thereby the insertion openings of the first holding recesses can have a first opening distance in a support transverse direction of the mattress support that is smaller than the first element distance.

It is further advantageous that the second fastening elements have a second element distance to the first fastening elements in mattress longitudinal direction. Thereby the insertion openings of the second holding recesses can have a second opening distance in a support longitudinal direction to the insertion openings of the first holding recesses that is smaller than the second element distance.

The mattress support is preferably arranged at a base part. The mattress support has preferably a main part and a foot part. The foot part is particularly arranged separately from the main part at the base part or a bed frame. The main part of the mattress support can be pivotable about a pivot axis S by means of a pivot device and/or can be movable parallel to the pivot axis or linearly shiftable. The pivot axis is substantially orientated in vertical direction or orthogonal to the ground on which the base part or the bed frame is installed.

It is preferred, if the mattress support and particularly the main part of the mattress support comprises at least three support sections, wherein two directly adjacent support sections are connected with each other by means of a hinge arrangement in pivotable manner. In an embodiment the mattress support comprises at least one back section, a central section that is connected with the back section in a hinged manner, as well as a lower leg section. The lower leg section can be connected with the central section in a hinged manner. Alternatively it is also possible that an additional thigh section, as a further support section, is present between the central section and the lower leg section that is connected with the central section and the lower leg section in a hinged manner.

It is preferred that the first holding recesses and the second holding recesses are assigned to different support sections. Preferably all of the first holding recesses can be arranged at one single support section and all of the second holding recesses can be arranged at one other support section. Preferably the second holding recesses are arranged at the lower leg section and the first holding recesses are arranged at the central section and/or the thigh section.

### BRIEF DESCRIPTION OF THE DRAWINGS

Preferred embodiments of the invention are derived from the dependent claims, the description and the drawings. In the following preferred embodiments of the invention are explained in detail with reference to the attached drawings. The drawings show:

FIG. 1 a schematic illustration of a mattress support in a top view, wherein the mattress support is in a lying position,

FIG. 2 a schematic top view of a bottom side of a mattress with a supplement mattress in its undeformed initial condition,

FIG. 3 a perspective view of the mattress of FIG. 2,

FIG. 4 a top view on the bottom side of the mattress of FIG. 3,

FIG. 5 a schematic principle illustration of a bed, wherein the mattress support with the mattress attached thereon is in a seat position,

FIG. 6 a schematic sectional partial illustration of a mattress with an attached fastening element,

FIG. 7 the mattress and the fastening element according to the illustration of FIG. 6, wherein the fastening element is arranged in a holding slot of a holding recess and

FIG. 8 an embodiment of a constructive configuration of a fastening element.

### DETAILED DESCRIPTION

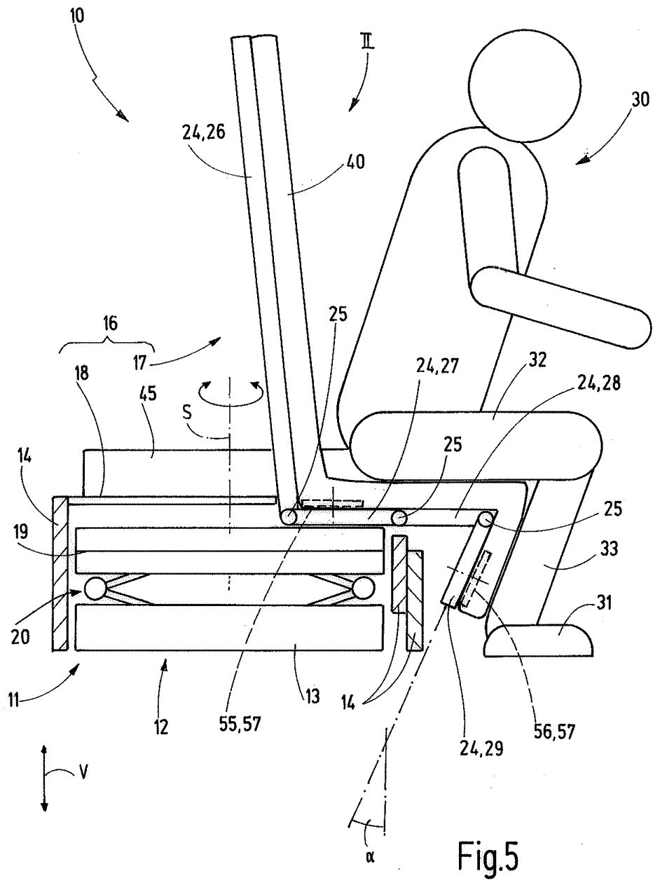

FIG. 5 shows in a highly schematical manner a bed in the form of a nursery bed 10 with a bed frame 11. A base part 12 is part of the bed frame 11 or is surrounded or supported by the bed frame 11. The base part 12 has a stand 13 by means of which the base part 12 can be placed on a ground in the embodiment. According to the embodiment, the bed frame has side elements 13 arranged at the sides that surround the base part 12.

The bed frame 11 and according to the example the base part 12 support a mattress support 16. The mattress support 16 has a main part 17 and a foot part 18. According to the example the foot part 18 is arranged on the bed frame 11 and immovable relative to the bed frame. The main part 17 is separated from the foot part 18 and movable relative to the foot part 18. In the embodiment the main part 17 of the mattress support 16 is supported on the base part 12. For moving the main part 17 the base part 12 comprises a pivot device 19 and lift device 20. By means of the pivot device 19 the mattress main part 17 can be pivoted about a pivot axis S. In the embodiment the pivot axis S extends substantially in vertical direction V or orthogonal to a ground, on which the bed frame 11 or the base part 12 is placed. By means of the lift device 20, the main part 17 of the mattress support 16 can be lifted and lowered parallel to the pivot axis S and according to the example in vertical direction V.

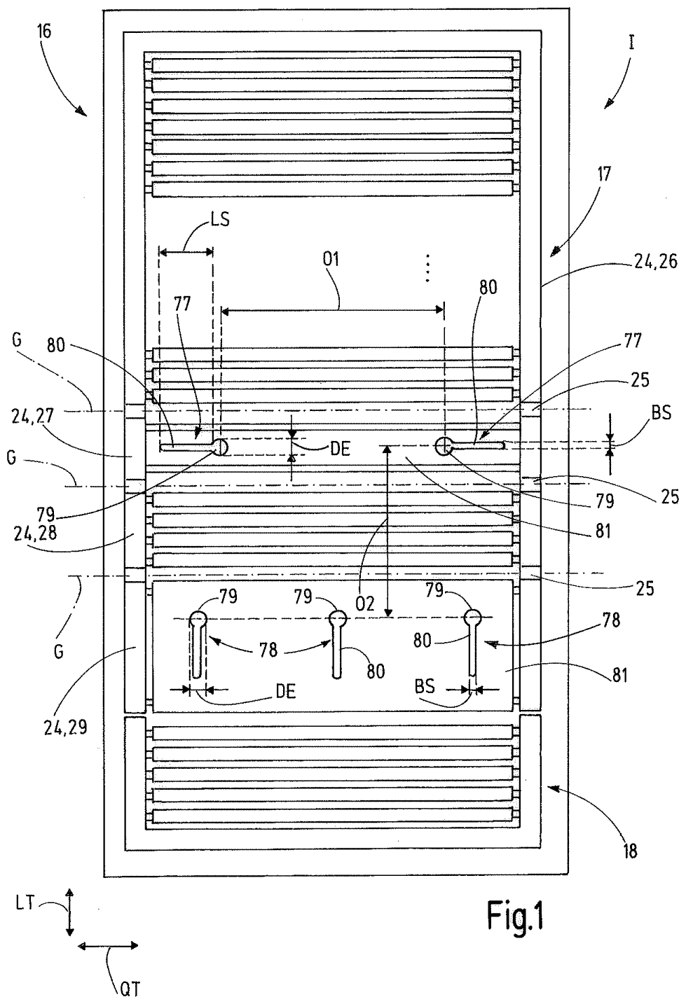

In the embodiment the mattress support 16 comprises multiple support sections 24 that are connected with each other in a hinged manner and can be angled relative to each other. In the embodiment the main part 17 of the mattress support 16 is divided in multiple and according to the example in at least three or four support sections 24. Two directly adjacent support sections 24 are connected with each other by a hinge arrangement 25 in a hinged manner in each case. The hinge axes G of the hinge arrangements 25 extend parallel to each other in a support transverse direction QT of the mattress support 16 or the main part 17 of the mattress support 16 (FIG. 1). The hinge axes G are orientated orthogonal to the pivot axis S.

The hinge arrangements 25 as well as the lift device 20 and the pivot device 19 can be operated by a motor and, for example, by an electric motor. The operation by an electric motor can be controlled by a non-illustrated operating device. As an alternative thereto it would also be possible to operate one or more of these devices mechanically with a handle, e.g. the lift device 20 could be controlled or operated by means of a foot pedal and/or the hinge arrangements 25 could be controlled or operated by means of a hand lever in each case.

By means of the hinge arrangements 25, the support sections 24 can be brought in a lying position I of the mattress support 16 illustrated in FIG. 1, in which the support sections 24 are orientated substantially parallel to a common plane, wherein this plane is formed by the support transverse direction QT and a support longitudinal direction LT that is orientated orthogonal thereto. One or more support sections 24 can be moved out of this lying position I by tilting about a hinge axis G, e.g. in a seat position II (FIG. 5).

In the embodiment illustrated in FIG. 5 the main part 17 comprises four support sections 24: a back section 26, a central section 27, a thigh section 28 and a lower leg section 29. The back section 26 is connected with the central section 27 by means of a hinge arrangement 25 in a hinged manner. The thigh section 28 is connected with the central section 27 in a hinged manner by means of a hinge arrangement 25 and is connected with the lower leg section 29 in a hinged manner by means of a further hinge arrangement 25. The thigh section 28 can also be omitted as an option, wherein the lower leg section 29 is connected with the central section 27 directly by means of a hinge arrangement 25 in this case.

In the seat position II of the mattress support 16 or the main part 17 of the mattress support 16 shown in FIG. 5 the back section 26 is raised similar to the back of a chair. The adjoining central section 27 extends substantially orthogonal to the pivot axis S or to the vertical direction V similar to a seating surface of a chair. In the exemplary seat position the thigh section 28 extends the central section 27 substantially horizontally or orthogonal to the pivot axis S. In the seat position II the lower leg section 29 extends downward in vertical direction V and according to the example concurrently backward. In doing so, the free end of the lower leg section 29 opposite the thigh section 28 is arranged below a support section 24 (e.g. thigh section 28 or central section 27) forming the seating surface. The plane in which the lower leg section 29 extends encloses an angle α with the vertical direction V that is larger than zero and has, according to the example, an amount of at least 10° or at least 15° or at least 20°. Due to this orientation of the lower leg section 29, it is possible for a patient 30 to place his/her feet 31 on the ground in a manner such that the heel is located below the thigh 32. A lower leg 33 of the patient 30 thereby extends inclined with regard to the vertical direction V. In this position standing up is facilitated for the patient 30, because he can shift his upper body more simply forward above the feet 31.

In a modified embodiment the back section 26 of the main part 17 can be divided by means of a further hinge arrangement 25 such that in addition a further support section 24 is present that can form a head section.

In order for the main part 17 of the mattress support 16 to be brought in the seat position II shown in FIG. 5, the bed frame 11 can comprise at one longitudinal side of the bed frame 11 a side element 14 that can be at least partly lowered or moved. For example, at least one side element 14 can be separated into two parts, wherein the other part can be moved in vertical direction V relative to the lower part of the side element 14. In doing so, the central section 27 and/or the thigh section 28 can extend beyond the respective side element 14 of the bed frame 11 in the seat position II of the mattress support 16 in order to allow the patient 30 to stand up adjacent to the bed frame 11.

The mattress support 16 is configured to support a mattress 40. The mattress 40 comprises a bottom side 41 facing the mattress support, a top side 42 opposite the bottom side 41, two longitudinal sides 43 extending in a mattress longitudinal direction LM and two transverse sides 44 extending in a mattress transverse direction QM. According to the example, the mattress 40 is supported by the main part 17. A supplement mattress 45 is configured separately from the mattress 40 and is placed on the foot part 18 of the mattress support 16. The supplement mattress 45 thus serves as support for the feet of the patient, if the mattress support 16 is in the lying position I.

The mattress 40 and according to the example the supplement mattress 45 have a mattress width BM in mattress transverse direction QM. The length of the mattress 40 in mattress longitudinal direction LM is remarkably longer than that of the supplement mattress 45.

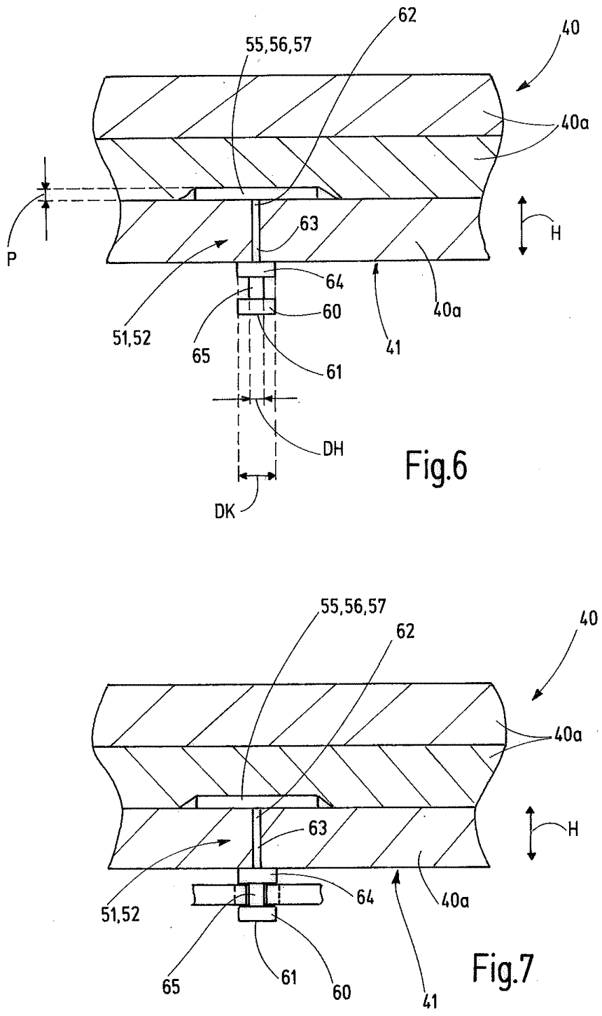

For releasably attaching the mattress 40 on the mattress support 16 or the main part 17 of the mattress support 16, a fastening device 50 is provided. The fastening device 50 comprises first fastening elements 51 and second fastening elements 52 on the mattress side, as well as first holding recesses 53 and second holding recesses 54 on the support side. The fastening elements 51, 52 project from the bottom side 41 of the mattress 40. The first fastening elements 51 are attached at an assigned first plate-shaped holding part 55 and the second fastening elements 52 are attached at one assigned second plate-shaped holding part 56 respectively. In the embodiment the plate-shaped holding parts 55, 56 are configured as holding plate 57 in each case that is integrally made without seam or joint from a continuous material. For example, the holding plate 57 is configured as plastic plate and consists preferably of polyethylene. The holding plate 57 has a plate thickness P in a height direction H orthogonal to the mattress longitudinal direction LM and orthogonal to the mattress transverse direction QM of some millimeters and preferably less than 5 mm. In the embodiment the plate thickness P has an amount of some millimeters and preferably less than 5 mm. In the embodiment the plate thickness P has an amount of 3 mm (FIG. 6).

By means of the plate-shaped holding parts 55, 56, the fastening elements 51, 52 are attached to the mattress 40. According to the example, this is realized in that the plate-shaped holding parts 55, 56 are arranged in the inside of the mattress 40. It is apparent from FIGS. 6 and 7 that the mattress 40 is made from multiple layers 40a. Between two layers 40a that directly abut against each other, the respective plate-shaped holding part 55, 56 can be arranged. The two layers 40a can be glued subsequently and the holding parts 55, 56 can be fixed in between. Preferably all of the holding parts 55, 56 are arranged in a common plane, according to the example adjacent to the lower most layer 40a of the mattress 40 that comprises the bottom side 41.

The fastening elements 51, 52 extend through the lower most layer 40a. The fastening elements 51, 52 have a fastening head 60 respectively that is arranged with distance to the bottom side 41 of the mattress 40. The fastening head 60 is located at the outer end 61 or forms the outer end 61 of the fastening element 51, 52. The fastening element 51, 52 is attached to the assigned holding plate 57 by an inner end 62 opposite the outer end 61. Adjoining the inner end 62 the fastening element 51, 52 has a shank 63 that extends through the mattress 40 and according to the example the lower most layer 40a of the mattress 40.

An abutment part 64 of the fastening element 51, 52 is supported on the bottom side 41. The fastening element 51, 52 has a neck part 65 between the abutment part 64 and the fastening head 60. The neck part 65 has a neck diameter DH orthogonal to the height direction. The fastening head 60 has a head diameter DK orthogonal to the height direction. The head diameter DK is larger than the neck diameter DH. The diameter of the abutment part 64 can correspond to the head diameter DK.

In the illustrated embodiment the fastening head 60, the neck part 65, as well as the abutment part 64 have a circular contour respectively with view in height direction H. Different thereto the contour could also have arbitrary other shapes. Instead of the diameter, the mentioned parts then have a respective dimension in mattress transverse direction QM and in mattress longitudinal direction LM. At least the cross-sectional area of the neck part is also in this case smaller than that of the fastening head 60.

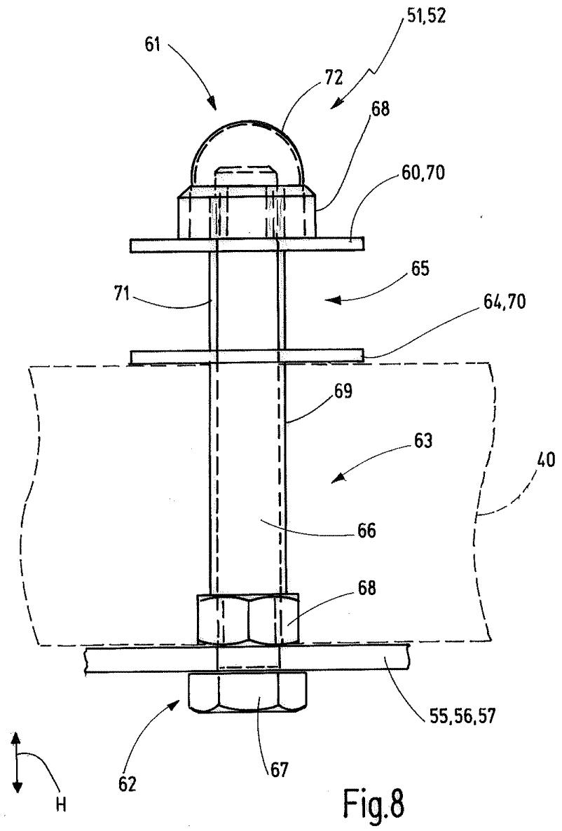

FIG. 8 illustrates an embodiment for a fastening element 51, 52. The fastening element 51, 52 comprises a screw 66 with a screw head 67 that forms the inner end 62. The screw 66 is inserted through a hole in the assigned holding plate 57 and attached to the holding plate 57 by means of the screw head 67 and a locking nut 68. Thereby the holding plate 57 is engaged in a clamping manner between the screw head 67 and the locking nut 68.

Adjoining the locking nut 68 a first sleeve 69 is mounted on the screw 66 in the area of the shank 63. The locking nut 68 and the first sleeve 69 form the shank 63. The abutment part 64 abuts against the first sleeve 69, wherein the abutment part 64 is formed by a washer 70 according to the example. The neck part 65 is formed by a second sleeve 71 that is mounted on the screw 66. The second sleeve 71 extends between the abutment part 64 and the fastening head 60. According to the example, the fastening head 60 is also formed by a washer 70 that can be identical with the washer 70 of the abutment part 64.

In the area of the outer end 61 a further locking nut 68 is screwed onto the screw 66 that locks the sleeves 69, 71 and the washer 70. As an option, a cap 62 can be mounted on the end of the screw 66 opposite the screw head 67, wherein the cap can have a half-spherical shape according to the example.

In the embodiment all of the fastening elements 51, 52 are configured identically and can have, e.g. a configuration shown in FIG. 8 and explained above.

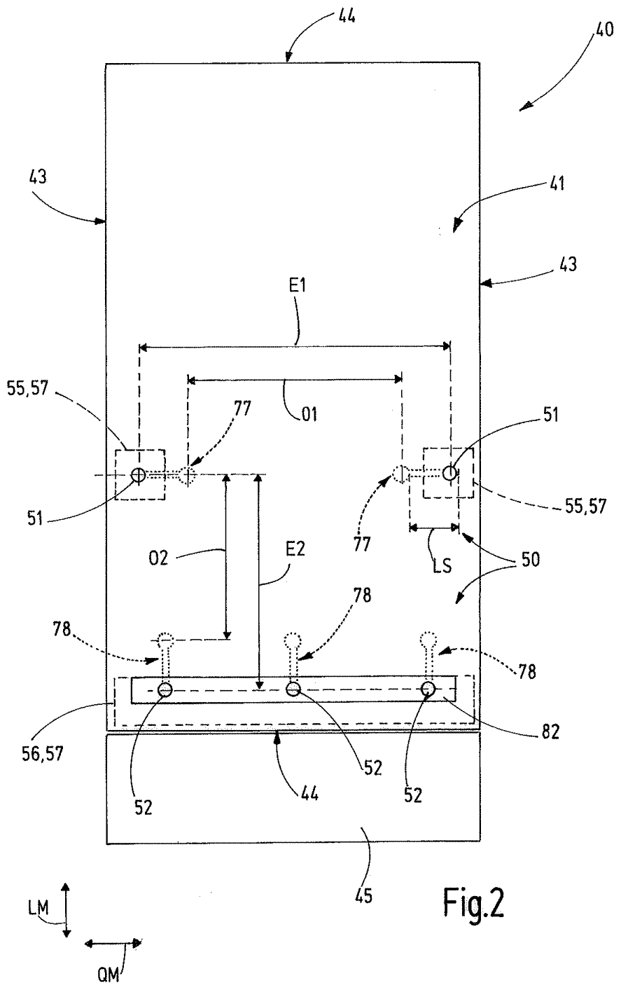

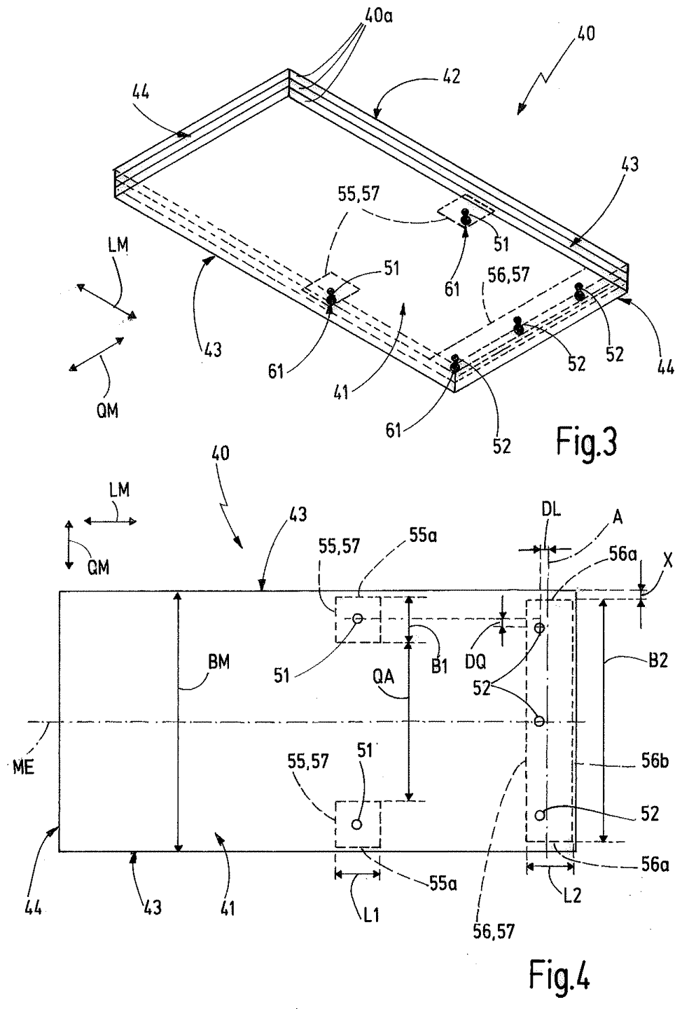

As is illustrated in FIGS. 2-4 exactly one first fastening element 51 is attached to each first plate-shaped holding part 55. According to the example, two first plate-shaped holding parts 55 are provided. It is further apparent that only one single second plate-shaped holding part 56 is provided to which all of the second fastening elements 52 (according to the example, three second fastening elements 52) are attached.

As shown in FIG. 4, two first plate-shaped holding parts 55 are provided that have a transverse distance QA in mattress transverse direction QM. According to the example, the transverse distance QA is at least as large as the half mattress width BM in mattress transverse direction QM. The transverse distance QA is larger than a first width B1 of the first plate-shaped holding parts 55 in mattress transverse direction QM. The first plate-shaped holding parts 55 have a first length L1 in mattress longitudinal direction LM. According to the example, the first length L1 is equal to the first width B1. The area of the first plate-shaped holding parts 55 parallel to the plain spanned by the mattress longitudinal direction LM and the mattress transverse direction QM comprises a surface area of at least 100 cm² or at least 200 cm². According to the example, the surface area has an amount of about 225 cm².

Each first plate-shaped holding part 55 has a longitudinal edge 55a that is orientated parallel to the adjacent longitudinal side 43 of the mattress 40 respectively. Due to this straight longitudinal edge 55a, first plate-shaped holding parts can be arranged close to the respective longitudinal side 43 of the mattress 40 and in addition, cover a sufficiently large surface area. In addition, the transverse distance QA can be selected sufficiently large.

The plate-shaped holding part 56 has a second width B2 that is larger than the half mattress width BM and has an amount of particularly 70% or 80% or 90% of the mattress width BM. The second plate-shaped holding part 56 has a second length L2 in mattress longitudinal direction LM that is equal to the first length L1 according to the example. The second plate-shaped holding part 56 has a longitudinal edge 56a adjacent to each longitudinal side 43 of the mattress 40 that extends parallel to the adjacent longitudinal side 43. Adjacent to a transverse side 44 of the mattress 40 the second plate-shaped holding part 56 has a transverse edge 56b that extends parallel to the transverse side 44. Parallel to the plane that is spanned by the mattress longitudinal direction LM and the mattress transverse direction QM, the second plate-shaped holding part 56 has a surface area of at least 800 cm² or at least 1,000 cm² or at least 1,200 cm². According to the example, the second width B2 has an amount of 80 cm when the mattress width BM has an amount of 100 cm.

As is apparent from FIG. 4, each longitudinal edge 56a of the second plate-shaped holding part 56 has a lateral distance X from the respective directly adjacent longitudinal side 43 of the mattress 40. The lateral distance X has an amount of preferably at most 15 cm and in the embodiment at most 10 cm. The transverse edge 56b of the second plate-shaped holding part 56 can have a lateral distance to the adjacent transverse side 44 of the mattress 40 analog thereto, the amount of which can be selected equal to the lateral distance X or smaller.

The longitudinal edges 55a of the first plate-shaped holding parts 55 have a distance to the directly adjacent longitudinal side 43 of the mattress 40 respectively that corresponds at most to the lateral distance X and is smaller according to the embodiment.

In modification to the illustrated embodiment the plate-shaped holding parts 55, 56 or the holding plates 57 can also have another contour than a square or rectangular contour. The square or rectangular contours have the advantage that the longitudinal edges 55a, 56a or the transverse edges 56b of the plate-shaped holding parts 55 or 56 can be arranged very closely to the respective longitudinal side 43 or transverse side 44 of the mattress 40.

It is also apparent from FIG. 4 that the second fastening elements 52 are not centrally arranged in mattress longitudinal direction, but are arranged offset to the central axis A of the second plate-shaped holding part 56 and according to the example, are offset from the central axis A away from the closer transverse side 44 of the mattress 40 about a longitudinal offset DL.

The two outer second fastening elements 52 in mattress transverse direction QM are farther away from the adjacent longitudinal side 43 about a transverse offset DQ than the respective outer first fastening elements 51 in mattress transverse direction QM.

Preferably exactly three plate-shaped holding parts 55, 56 or holding plates 57, two first fastening elements 51 and at least two second fastening elements 52 and according to the example, exactly three second fastening elements 52 are provided. It is also preferred, if the plate-shaped holding parts 55, 56 and the fastening elements 51, 52 are arranged symmetrically relative to a longitudinal central plane ME extending through the mattress 40.

Based on the illustration in FIG. 2, it is apparent that the two first fastening elements 51 have a first element distance E1 in mattress transverse direction QM that is measured from center to center respectively. The second fastening elements 52 have a second element distance E2 from the first fastening elements 51 in mattress longitudinal direction LM that is also measured from center to center of the fastening elements 51, 52.

In the mattress support 16 and according to the example the main part 17, multiple holding recesses are provided, wherein for each of the first fastening elements 51 a first holding recess 77 and for each second fastening element 52 a second holding recess 78 is provided. Each holding recess 77, 78 has an insertion opening 79 and a holding slot 80 adjoining the insertion opening. The insertion opening 79 have an insertion diameter DE that is slightly larger than the head diameter DK of the fastening elements 51, 52. In doing so, the fastening head 60 can be inserted through the insertion opening 79. A slot width BS of the holding slot 80 is smaller than the insertion diameter DE and smaller than the head diameter DK. The slot width BS is larger than the neck diameter DH of the fastening elements 51, 52. In doing so, the fastening element 51, 52 can be inserted with its respective neck part 65 in the holding slot 80 and can be shifted along the holding slot 80. Thereby the fastening head extends below a respective support plate 81 of the mattress support 16 in which the respective holding recess 77, 78 is arranged. The holding recesses 77, 78 extend completely through the respective support plate 81.

The holding slots 80 of the two first holding recesses 77 extend in support transverse direction QT. The two first holding recesses 77 are arranged such that the insertion openings 79 are arranged inward at the respective holding recess 77 and thus are arranged at adjacent ends and that the holding slots extend away outwardly from the respective insertion opening and away from the respective other holding recess 77 so-to-speak.

The second holding recesses 78 respectively have a holding slot 80 that extends in support longitudinal direction LT of the mattress support 16. The holding slots 80 extend originating from the respective insertion opening 79 away and according to the example, away from the first holding recesses 77.

The support plate 81 with the first holding recesses 77 is located in the central section 27 of the mattress support 16 according to the example and the support plate 81 with the second holding recesses 78 is located in the lower leg section 29 of the mattress support 16 according to the example. In modification to the illustrated embodiment, a support plate 81 with first holding recesses 77 could be arranged additionally or alternatively also in the thigh section 28. It is preferred, if the support plate 81 with the first holding recesses 77 is arranged as close as possible or directly adjoining the hinge arrangement 25 that connects the central section 27 with the back section 26 in a hinged manner. In each case the first holding recesses 77 and the second holding recesses 78 are not provided in the same support sections 24.

As apparent from FIGS. 1 and 2, the insertion opening 79 of the first holding recesses 77 have a first opening distance O1 in support transverse direction QT that is measured from center to center of the insertion openings 79 respectively. The first opening distance O1 is smaller than the first element distance E1 of the assigned first fastening elements 51.

The insertion opening 79 of the second holding recesses 78 have a second opening distance O2 from the insertion opening 79 of the first holding recesses 77 in support longitudinal direction LT. The second opening distance O2 is smaller than the second element distance E2 between the first fastening elements 51 and the second fastening elements 52 in support longitudinal direction LT.

The holding slots 80 of the first holding recesses 77 have a slot length LS starting from the insertion opening 79 up to their opposite end. The transverse distance QA between the two first plate-shaped holding parts 55 is at least as large as the slot length LS. Preferably the slot length LS of all of the holding slots 80 of all of the holding recesses 77, 78 is equal. The slot length LS is larger than the diameter DE of the insertion openings 79.

FIG. 2 also shows another optional configuration for fastening the second fastening elements 52 at the mattress 40. With distance to the second plate-shaped holding part 56 or the holding plate 57, a strip 82 can be placed on the bottom side 41 of the mattress 40. The strip 82 can be manufactured, e.g. from plastic and can have through-holes for all of the second fastening elements 52. The strip 82 can be used as common abutment part 64 of the second fastening elements 52 or can be placed in addition between the bottom side 41 of the mattress and the respective abutment parts 64.

The fastening of the mattress 40 to the main part 17 of the mattress support 16 can be carried out as described in the following for example:

For attaching the first fastening elements 51 to the first holding recesses 77, first the fastening head 60 of a first fastening element 51 is inserted through the assigned insertion opening 79 and the neck part is inserted in the holding slot 80 and shifted away from the insertion opening 79. The mattress 40 is compressed in mattress transverse direction QM until also a fastening head 60 of the respective other first fastening element 51 can be inserted through the assigned insertion opening 79. If the elastic deformation of the mattress 40 is then released, the mattress 40 urges the two first fastening elements 51 away from each other, such that the neck parts 65 extend through the respective holding slot 80 and the fastening head 60 extend beyond the support plate 81 on the side of the support plate 81 opposite the bottom side 41 of the mattress 40.

Subsequently, the end of the mattress 40 assigned to the lower leg section 29 and comprising the second fastening elements 52 can be moved in mattress longitudinal direction LM by elastic deformation or bending of the mattress 40 such that the fastening heads 60 of the second fastening elements 52 can be inserted in the insertion opening 79 of the second holding recesses 78. If the mattress 40 is then released, the force created due to the elastic deformation of the mattress 40, urges the neck parts 65 in the associated holding slots 80 and the fastening heads 60 can extend beyond the support plate 81 having the second holding recesses 78 in the area of the holding slots 80. The mattress 40 is then releasably attached to the mattress support 16.

For releasing the mattress 40 from the mattress support 16, it can be proceeded in reverse order. By shifting of the fastening elements 51, 52 along the holding slots 80, the fastening heads can be arranged in the area of the respective insertion opening 79 and removed through the insertion opening 79 from the mattress support 16.

The order in which the first and second fastening elements 51, 52 can be arranged on the mattress support 16 or in the respective assigned holding recess 77 or 78 or else can be removed therefrom, can be modified. For example, it is possible to first arrange the second fastening elements 52 in the second holding recesses 78 and subsequently arrange the first fastening elements 51 in the first holding recesses 77.

As apparent from FIG. 5, the mattress 40 is fixed on the main part 17 of the mattress support 16 by means of the fastening elements 51, 52. Because of the raising of the back section 26 and the fixing of the mattress 40 in the range of the central section 27, an additional fixation in the back section 26 can be omitted, because the mattress 40 presses against the back section 26 due to the elastic deformation. A fixing of the mattress 40 by means of the two first fastening elements 51 with the first element distance E1 is sufficient in this area. Because of the bend in the mattress 40 in the transition region between the central section 27 and the back section 26, the mattress 40 tends not to camber at this location.

The fixing of the mattress 40 in the area of the lower leg section 29 is of particular importance in order not to impede the lower legs 33 and the feet 31 of the patient 30. Particularly because the lower leg section 29 is pivoted below the thigh section 28 or the central section 27 (angle α relative to the vertical V), high elastic deformation forces act on the mattress 40 in the area of the lower leg section 29, the mattress 40 tends to release itself in this area from the lower leg section. Because the second fastening elements 52 are commonly attached at the second plate-shaped holding part 56 and the latter preferably extends nearly over the whole mattress width BM, these forces are supported via a sufficiently large area in the mattress 40 and avoid ripping of the second fastening elements 52 of the mattress 40. In addition, camber of the mattress 40 in the area of the edges between the longitudinal sides 43 and the transverse sides 44 can be avoided, because the mattress 40 is stiffened in this area by the second plate-shaped holding part 56.

The stiffening of the mattress 40 by the second plate-shaped holding part 56 is uncritical for the lying comfort. The lower legs 33 of the patient 30 lye on the mattress 40 in this section and thus only a low weight force acts on the top side 42 of the mattress 40. On the contrary, the center of gravity of the patient 30 is located in the area of the first fastening elements 51. There a sufficiently large transverse distance QA is selected between the first plate-shaped holding parts 55 in order to not or only marginally affect the lying comfort and in order to not effect a stiffening of the mattress 40 adversely influencing the lying comfort. However, a ripping of or breaking away of the first fastening elements 51 is avoided due to a sufficiently large area of the first plate-shaped holding parts 55. The durability of the fastening device 50 or the mattress 40 is guaranteed.

The invention refers to a fastening device 50 for attaching a mattress 40 to a mattress support 16 or a bed, particularly a nursery bed 10 with such a fastening device 50. The mattress support 16 comprises multiple support sections 24 that are connected with each other in a hinged manner. In the central section 27 of the mattress support 16 a support plate 81 with first holding recesses 77 is arranged. In a lower leg section 29 of the mattress support 16 a support plate 81 with second holding recesses 78 is arranged. First fastening elements 51 attached to the mattress are assigned to the first holding recesses and second fastening elements 52 attached to the mattress 40 are assigned to the second holding recesses 78. The first fastening elements 51 are attached to at least two first plate-shaped holding parts 55 that are arranged under formation of a transverse distance QA on opposite sides of the mattress 40 in a mattress transverse direction QM. The second fastening elements 52 are preferably arranged at one single common second plate-shaped holding part 56 that extends along more than half of the mattress width BM in mattress transverse direction QM and preferably nearly along the whole mattress width EM.

### LIST OF REFERENCE SIGNS

10 bed
11 bed frame
12 base part
13 stand
14 side element of bed frame
16 mattress support
17 main part
18 foot part
19 pivot device
20 lift device
24 support section
25 hinge arrangement
26 back section
27 central section
28 thigh section
29 lower leg section
30 patient
31 foot of patient
32 thigh of patient
33 lower leg of patient
40 mattress
40a layer of mattress
41 bottom side of mattress
42 top side of mattress
43 longitudinal side of mattress
44 transverse side of mattress
45 supplement mattress
50 fastening device
51 first fastening element
52 second fastening element
53 first holding recess
54 second holding recess
55 first plate-shaped holding part
55a longitudinal edge of first plate-shaped holding part
56 second plate-like holding part
56a longitudinal edge of second plate-like holding part
56b transverse edge of second plate-like holding part
57 holding plate
60 fastening head
61 outer end of fastening element
62 inner end of fastening element
63 shank
64 abutment part
65 neck part
66 screw
67 screw head
68 locking nut
69 first sleeve
70 washer
71 second sleeve
72 cap
77 first holding recess
78 second holding recess
79 insertion opening
80 holding slot
81 support plate
82 strip
I lying position
II seat position
α angle
A central axis
BM mattress width
B1 first width
B2 second width
BS slot width
DE insertion diameter
DH neck diameter
DK head diameter
DL longitudinal offset
DQ transverse offset
E1 first element distance
E2 second element distance
G hinge axis
H height direction
LM mattress longitudinal direction
LS slot length
LT support longitudinal direction
ME longitudinal central plane
O1 first
O2 second
P plate thickness
QA transverse distance
QM mattress transverse direction
QT support transverse direction
S pivot axis
V vertical direction
X lateral distance

1. A fastening device for attaching a mattress to a mattress support, wherein the mattress comprises a bottom side, a top side opposite the bottom side, two longitudinal sides extending in a longitudinal direction of the mattress and two transverse sides extending in a transverse direction of the mattress,
at least two first plate-shaped holding parts that are arranged with a transverse distance to each other in the transverse direction of the mattress and having at least one second plate-shaped holding part that is larger in the transverse direction of the mattress than half a width of the mattress, wherein the plate-shaped holding parts are arranged at the mattress,
multiple first fastening elements and multiple second fastening elements that project from the bottom side of the mattress and comprise a fastening head with a distance to the bottom side of the mattress, wherein at least one first fastening element is attached to each of the at least two first plate-shaped holding parts and wherein multiple second fastening elements are attached to the at least one second plate-shaped holding part, and
multiple first holding recesses and multiple second holding recesses at the mattress support, each comprising an insertion opening and a holding slot adjoining thereto, wherein an outer dimension of the insertion opening is larger than an outer dimension of the fastening head such that the fastening head can be inserted in the assigned insertion opening and wherein a slot width of the holding slot is smaller than the outer dimension of the fastening head.

2. The fastening device according to claim 1, wherein the holding slots of the first holding recesses extend in a support transverse direction and/or that the holding slots of the second holding recesses extend in a support longitudinal direction.

3. The fastening device according to claim 2, wherein the transverse distance is at least as large as the slot length of a holding slot of one of the first holding recesses.

4. The fastening device according to claim 1, wherein the first plate-shaped holding parts and/or the at least one second plate-shaped holding part each comprise at least one longitudinal edge that extends parallel to a directly adjacent longitudinal side of the mattress.

5. The fastening device according to claim 1, wherein all of the second fastening elements are attached to a common second plate-shaped holding part.

6. The fastening device according to claim 1, wherein exactly one first fastening element is attached to each first plate-shaped holding part.

7. The fastening device according to claim 1, wherein a width of the at least one second plate-shaped holding part has an amount of at least 70% or at least 80% or at least 90% of the mattress width.

8. the fastening device according to claim 1, wherein the second plate-shaped holding part or one of the provided second plate-shaped holding parts comprises a transverse edge that extends parallel to an adjacent transverse side of the mattress.

9. The fastening device according to claim 1, wherein at least two of the fastening elements have an element distance in a non-deformed initial position of the mattress in the longitudinal direction of the mattress and/or in the transverse direction of the mattress that is different from an opening distance that the insertion openings of the holding recesses comprise that are associated to the fastening elements.

10. The fastening device according to claim 1, wherein two first fastening elements have a first element distance in the transverse direction of the mattress.

11. The fastening device according to claim 10, wherein the mattress support comprises first holding recesses, the insertion openings each have a first opening distance in a support transverse direction that is smaller than the first element distance.

12. The fastening device according to claim 1, wherein the second fastening elements have a second element distance from the first fastening elements in the longitudinal direction of the mattress.

13. The fastening device according to claim 12, wherein the mattress support comprises second holding recesses, the insertion opening of which have a second opening distance from the insertion openings of the first holding recesses in a support longitudinal direction that is smaller than the second element distance.

14. The fastening device according to claim 1, wherein the mattress support is arranged on a base part and comprises a main part and a foot part that is arranged on the base part or a bed frame separately from the main part.

15. The fastening device according to claim 14, wherein the main part of the mattress support is pivotably supported about a pivot axis by means of a pivot device of the base part and/or that the main part of the mattress support is movable in a vertical direction by means of a lift device of the base part.

16. The fastening device according to claim 1, wherein the mattress support has at least three support sections, wherein directly adjacent support sections are pivotably connected with each other by means of a hinge arrangement respectively.

17. The fastening device according to claim 16, wherein the first holding recesses and the second holding recesses are arranged at different support sections.

18. A nursing bed having a mattress support, having a mattress and having a fastening device according to claim 1, by means of which the mattress can be removably attached to the mattress support.

19. The fastening device according to claim 3, wherein the first plate-shaped holding parts and/or the at least one second plate-shaped holding part each comprise at least one longitudinal edge that extends parallel to a directly adjacent longitudinal side of the mattress.

20. The fastening device according to claim 19, wherein all of the second fastening elements are attached to a common second plate-shaped holding part.
